(19) United States
(12) Patent Application Publication
(10) Pub. No.: US 2023/0390672 A1
(43) Pub. Date: Dec. 7, 2023

(54) IMPROVED FLOCCULANTS

(71) Applicant: UNIVERSITY OF KENTUCKY RESEARCH FOUNDATION, Lexington, KY (US)

(72) Inventors: J. Zach Hilt, Lexington, KY (US); Thomas Dziubla, Lexington, KY (US); Angela Gutierrez, Lexington, KY (US); Molly E. Frazar, Lexington, KY (US); Rishabh Shah, Lexington, KY (US); Shuo Tang, Lexington, KY (US); Skyler Hornback, Lexington, KY (US)

(21) Appl. No.: 18/249,143

(22) PCT Filed: Oct. 15, 2021
(86) PCT No.: PCT/US2021/055274

§ 371 Date: Apr. 14, 2023

Related U.S. Application Data
(60) Provisional application No. 63/092,338, filed on Oct. 15, 2020.
(60) Provisional application No. 63/092,367, filed on Oct. 15, 2020.

(51) Int. Cl. B01D 21/01; B03D 3/06; C02F 1/52

(52) U.S. Cl. CPC B01D 21/01; C02F 1/52; B03D 3/06

(57) ABSTRACT

The present invention provides random multi-component polymers, methods to prepare the random multi-component polymers, methods for removing soluble species or insoluble particles from an aqueous solution, and methods for removing soluble species or insoluble particles from an aqueous solution in the human body

### CROSS-REFERENCE TO RELATED APPLICATION

This application claims benefit of U.S. Provisional Patent Applications Nos. 63/092,338 and 63/092,367, which were filed in the United States Patent and Trademark Office on Oct. 15, 2020, the entire contents of which are incorporated herein by reference for all purposes

### FIELD OF THE INVENTION

The present disclosure generally relates to flocculants, and more particularly to random multi-component polymers useful as flocculants.

### BACKGROUND OF THE INVENTION

Water remediation utilizing sorption has found strong interest due to its inexpensiveness, universal nature, and ease of operation. In particular, thermo-responsive sorbents consisting of N-isopropylacrylamide (NIPAAm) offer significant potential as “smart” and advanced particles to remove multiple aqueous pollutants (soluble and insoluble pollutants). NIPAAm exhibits excellent thermo-responsiveness, which senses the external temperature variation and changes its swelling and sorption behaviors in a sharp and rapid manner. Poly(NIPAAm) have been shown to induce flocculation in particle suspension at temperature above its LCST (low critical solution temperature). This flocculation occurs through hydrophobic association of polymer chains and removes various aqueous pollutants (particles). Yet, the flocculation using poly(NIPAAm) is insufficient to remove a majority of these aqueous pollutants (particles) and requires multiple treatments.

What is needed are improved random multi-component polymers with enhanced flocculation properties above the LCST (low critical solution temperature). The random multi-component polymers would have a variety of applications in aqueous pollutant removal and a promising class of particles for cost-effective water remediation technology.

### SUMMARY OF THE INVENTION

In one aspect, disclosed herein, are random multi-component polymers or salts thereof, the random multi-component polymers comprising two or more monomer components; wherein the random multi-component polymers or salts thereof are water miscible and associates with a soluble species or insoluble particle below a specific temperature and then at or above a specific temperature, converts to a flocculated random multi-component polymers or salts thereof is hydrophobic and easily separated from water.

In another aspect, disclosed herein, are random multi-component polymers and salts thereof which impart a temperature responsiveness, the random multi-component polymers wherein there are at least three key building blocks comprising:
a. from about 50 wt % to about 99.8 wt % of the compound of Formula (I);
b. from about 0 wt % to about 50 wt % of the compound of Formula (II); and
c. from about 0 wt % to about 50 wt % of the compound of Formula (III);
wherein

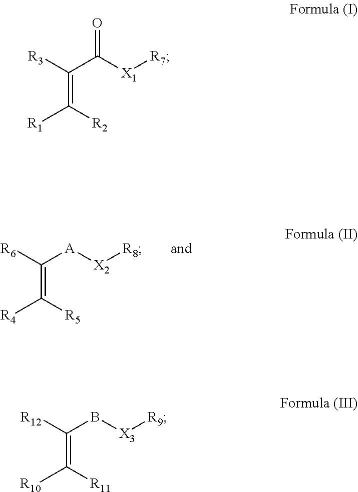

wherein A and B are independently —CH₂— or C(═O);
wherein X₁, X₂, and X₃ are independently CR₁₃R₁₄, O, NR₁₅, NH, S, substituted aryl, unsubstituted aryl, substituted heteroaryl, or unsubstituted heteroaryl; wherein R₁, R₂, R₃, R₄, R₅, R₆, R₁₀, R₁₁, and R₁₂ are independently hydrogen, substituted C₁-C₁₀ alkyl, unsubstituted C₁-C₁₀ alkyl, substituted C₁-C₁₀ alkenyl, unsubstituted C₁-C₁₀ alkenyl, substituted C₁-C₁₀ alkoxy, unsubstituted C₁-C₁₀ alkoxy, substituted C₁-C₁₀ alkynyl, or unsubstituted C₁-C₆ alkynyl;
wherein R₇, R₈, or R₉ are independently absent or selected from a group consisting of hydrogen, substituted C₁-C₁₀ alkyl, unsubstituted C₁-C₁₀ alkyl, substituted C₄-C₈ cycloalkyl, unsubstituted C₄-C₈ cycloalkyl, substituted C₁-C₁₀ alkenyl, unsubstituted C₁-C₁₀ alkenyl, substituted C₄-C₈ cycloalkenyl, unsubstituted C₄-C₈ cycloalkenyl, substituted C₁-C₁₀ alkynyl, unsubstituted C₁-C₁₀ alkynyl; substituted aryl, unsubstituted aryl, substituted heteroaryl, and unsubstituted heteroaryl; and
wherein R₁₃, R₁₄, and R₁₅ are independently hydrogen, substituted C₁-C₁₀ alkyl, unsubstituted C₁-C₁₀ alkyl, substituted C₄-C₈ cycloalkyl, unsubstituted C₄-C₈ cycloalkyl, substituted C₁-C₁₀ alkenyl, unsubstituted C₁-C₁₀ alkenyl, substituted C₄-C₈ cycloalkenyl, unsubstituted C₄-C₈ cycloalkenyl, substituted C₁-C₁₀ alkynyl, unsubstituted C₁-C₁₀ alkynyl; substituted aryl, unsubstituted aryl, substituted heteroaryl, or unsubstituted heteroaryl.

In another aspect, disclosed herein, are processes for preparing the random multi-component polymers or a salts thereof, the process comprises contacting the compound of Formula (I) with the compound of Formula (II) and the compound of Formula (III) to form a random multi-component polymer according to the following reaction scheme:

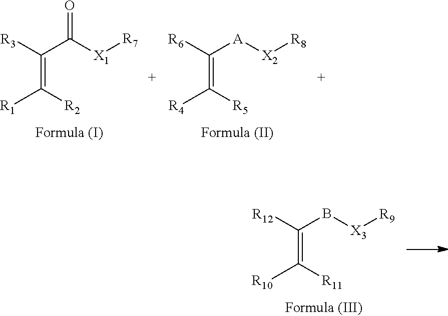

wherein A and B are independently —CH₂— or C(═O);
wherein X₁, X₂, and X₃ are independently CR₁₃R₁₄, O, NR₁₅, NH, S, substituted aryl, unsubstituted aryl, substituted heteroaryl, or unsubstituted heteroaryl;
wherein R₁, R₂, R₃, R₄, R₅, R₆, R₁₀, R₁₁, and R₁₂ are independently hydrogen, substituted C₁-C₁₀ alkyl, unsubstituted C₁-C₁₀ alkyl, substituted C₁-C₁₀ alkenyl, unsubstituted C₁-C₁₀ alkenyl, substituted C₁-C₁₀ alkoxy, unsubstituted C₁-C₁₀ alkoxy, substituted C₁-C₁₀ alkynyl, or unsubstituted C₁-C₆ alkynyl;
wherein R₇, R₈, or R₉ are independently absent or selected from a group consisting of hydrogen, substituted C₁-C₁₀ alkyl, unsubstituted C₁-C₁₀ alkyl, substituted C₄-C₈ cycloalkyl, unsubstituted C₄-C₈ cycloalkyl, substituted C₁-C₁₀ alkenyl, unsubstituted C₁-C₁₀ alkenyl, substituted C₄-C₈ cycloalkenyl, unsubstituted C₄-C₈ cycloalkenyl, substituted C₁-C₁₀ alkynyl, unsubstituted C₁-C₁₀ alkynyl; substituted aryl, unsubstituted aryl, substituted heteroaryl, and unsubstituted heteroaryl; and
wherein R₁₃, R₁₄, and R₁₅ are independently hydrogen, substituted C₁-C₁₀ alkyl, unsubstituted C₁-C₁₀ alkyl, substituted C₄-C₈ cycloalkyl, unsubstituted C₄-C₈ cycloalkyl, substituted C₁-C₁₀ alkenyl, unsubstituted C₁-C₁₀ alkenyl, substituted C₄-C₈ cycloalkenyl, unsubstituted C₄-C₈ cycloalkenyl, substituted C₁-C₁₀ alkynyl, unsubstituted C₁-C₁₀ alkynyl; substituted aryl, unsubstituted aryl, substituted heteroaryl, or unsubstituted heteroaryl.
wherein A and B are independently —CH₂— or C(═O);
wherein X₁, X₂, and X₃ are independently CR₁₃R₁₄, O, NR₁₅, substituted alkyl, unsubstituted alkyl, unsubstituted aryl, or substituted aryl;
wherein R₁, R₂, R₃, R₄, R₅, and R₆ are independently hydrogen, methyl, ethyl, propyl, isopropyl, benzyl, ethylene, propylene, or phenyl;
wherein R₇, R₈, or R₉ are independently absent or selected from a group consisting of hydrogen, methyl, ethyl, propyl, isopropyl, benzyl, hexafluoroiso-propyl, 1H, 1H, 3H, hexafluorobutyl, 1H, 1H, 7H-dodecafluoroheptyl, 2,2,2-trifluoroethyl, 1H, 1H, 2H, 2H-heptafluorodecyl, 1H, 1H, 5H-octafluorodecyl, phenyl, 4-hydroxyphenyl, 4-hydroxy-3-ethylphenyl, 4 fluorophenyl, pentafluorophenyl, 2-hydroxyethyl, 3-hydroxypropyl, 2-aminoethyl, 3-aminopropyl; 2-carboxyethyl, 3 carboxypropyl, anthracene, phenanthrene, bi-phenyl, and cyclopentadienyl; and R₁₃, R₁₄, and R₁₅ are independently hydrogen, methyl, ethyl, isopropyl, or propyl.

In another aspect, disclosed herein, are methods of removing a soluble species or an insoluble particle from an aqueous solution, the methods comprise: (a) providing an aqueous solution comprising the soluble species or the insoluble particle; (b) treating the aqueous solution comprising the soluble species or the insoluble particle with the random multi-component polymer at room temperature to form a first reaction mixture; (c) stirring the first reaction mixture of the aqueous solution comprising the soluble species or the insoluble particle and the random multi-component polymer; (d) heating the first reaction mixture from step (c) above the lower critical solution temperature of the random multi-component polymer thereby promoting the random multi-component polymer to flocculate the soluble species or the insoluble particle; and (e) separating the flocculated particle from step (d). The method further comprises deflocculating the particle from step (e) and isolating the random multi-component polymer and the soluble species or the insoluble particles. This deflocculating method comprising: (f) suspending the flocculated particle from step (e) in water or combinations of water and an organic solvent; (g) lowering the temperature below the lower critical solution temperature; and (h) separating the random multi-component polymer from the soluble species or the insoluble particles.

In yet another aspect, disclosed herein, are methods of removing soluble species or insoluble particles from an aqueous solution in the human body, the methods comprise: (a) providing an aqueous solution comprising soluble species or insoluble particles in the human body; (b) treating the aqueous solution comprising the soluble species or the insoluble particles with a solution of the random multi-component polymer of claim 1 at room temperature to form a mixture in the body; (c) potentially providing mixing (rubbing, swishing, etc.) to the mixture of the aqueous solution comprising soluble species or insoluble particles and the random multi-component polymer; (d) allowing the body temperature to heat the mixture from step (c) above a lower critical solution temperature of the random multi-component polymer thereby promoting the random multi-component polymer to form a flocculated material; and (e) removing the flocculated material from step (d).

Other features and iterations of the invention are described in more detail below.

### BRIEF DESCRIPTION OF FIGURES

FIG. 1 is a series of photographs showing the various stages of isolation of a random multi-component polymer.

FIG. 2 is a graphical representation of various multi-component polymers and the determination of the lower critical solution temperature by measuring the transmittance versus the temperature (° C.).

FIG. 3 is a series of photographs showing the flocculation capability of the random multi-component polymer. The left photograph shows the random multi-component polymer initially mixed with perfluorooctanoic acid (PFOA) and perfluorooctane sulfonic acid (PFOS). The middle picture shows the random multi-component polymer flocculating the PFOA and PFOS in a 50° C. water bath. The left picture shows the final flocculated polymer.

FIG. 4 is a graphical representation showing the removal efficiency of PFOA and PFOS for these polymer systems.

FIG. 5 is a graphical representation shows the removal efficiency of various elements.

FIG. 6 is a graphical representation of various multi-component polymers and the determination of the lower critical solution temperature by measuring the transmittance versus the temperature (° C.).

FIG. 7 is a series of photographs showing the remaining Fe₃O₄ MONPs in the supernatant that were quantitatively measured using iron assay.

FIG. 8 is a graphical representation which shows NIPAAm 2PPMA_2.5 copolymer flocculant has removed over 90% of the suspended particles at all MONP concentrations.

### DETAILED DESCRIPTION OF THE INVENTION

Disclosed herein are random multi-component polymers useful as flocculants, methods for preparing these random polymeric polymers, and methods of using these random multi-component polymers to sequester the soluble species or the insoluble particle as flocculants.

These flocculants have been shown to sequester various soluble and insoluble particles from various aqueous streams with high efficiently.

### (I) Random Multi-Component Polymers

One aspect of the present disclosure encompasses random multi-component polymers or salts thereof, the random multi-component polymers comprising two or more monomer components; wherein the random multi-component polymers or salts thereof are water miscible and associates with a soluble species or insoluble particle below a specific temperature and then at or above a specific temperature, converts to a flocculated random multi-component polymers or salts thereof is hydrophobic and easily separated from water.

(II) Random Multi-Component Polymers Comprising Formula (I) Formula (II), and Formula (III) and their Physical Properties

One aspect of the present disclosure encompasses random multi-component polymers comprising Formula (I), Formula (II), and Formula (III) or a salt thereof which may be useful as flocculants: the random copolymer polymer comprising:
a. from about 50 wt % to about 99.8 wt % of the compound of Formula (I);
b. from about 0 wt % to about 50 wt % of the compound of Formula (II); and
c. from about 0 wt % to about 50 wt % of the compound of Formula (III);
wherein

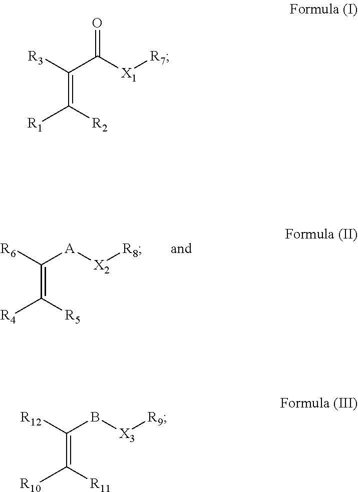

wherein A and B are independently —CH₂— or C(═O);
wherein X₁, X₂, and X₃ are independently CR₁₃R₁₄, O, NR₁₅, NH, S, substituted aryl, unsubstituted aryl, substituted heteroaryl, or unsubstituted heteroaryl;
wherein R₁, R₂, R₃, R₄, R₅, R₆, R₁₀, R₁₁, and R₁₂ are independently hydrogen, substituted C₁-C₁₀ alkyl, unsubstituted C₁-C₁₀ alkyl, substituted C₁-C₁₀ alkenyl, unsubstituted C₁-C₁₀ alkenyl, substituted C₁-C₁₀ alkoxy, unsubstituted C₁-C₁₀ alkoxy, substituted C₁-C₁₀ alkynyl, or unsubstituted C₁-C₁₀ alkynyl;
wherein R₇, R₈, or R₉ are independently absent or selected from a group consisting of hydrogen, substituted C₁-C₁₀ alkyl, unsubstituted C₁-C₁₀ alkyl, substituted C₄-C₈ cycloalkyl, unsubstituted C₄-C₈ cycloalkyl, substituted C₁-C₁₀ alkenyl, unsubstituted C₁-C₁₀ alkenyl, substituted C₄-C₈ cycloalkenyl, unsubstituted C₄-C₈ cycloalkenyl, substituted C₁-C₁₀ alkynyl, unsubstituted C₁-C₁₀ alkynyl; substituted aryl, unsubstituted aryl, substituted heteroaryl, or unsubstituted heteroaryl; and
wherein R₁₃, R₁₄, and R₁₅ are independently hydrogen, substituted C₁-C₁₀ alkyl, unsubstituted C₁-C₁₀ alkyl, substituted C₄-C₈ cycloalkyl, unsubstituted C₄-C₈ cycloalkyl, substituted C₁-C₁₀ alkenyl, unsubstituted C₁-C₁₀ alkenyl, substituted C₄-C₈ cycloalkenyl, unsubstituted C₄-C₈ cycloalkenyl, substituted C₁-C₁₀ alkynyl, unsubstituted C₁-C₁₀ alkynyl; substituted aryl, unsubstituted aryl, substituted heteroaryl, or unsubstituted heteroaryl.

Generally, A and B are independently —CH₂— or C(═O). In various aspects, A and B are independently —CH₂— or C(═O).

In general, X₁, X₂, and X₃ are independently CR₁₃R₁₄, O, NR₁₅, NH, S, substituted aryl, unsubstituted aryl, substituted heteroaryl, or unsubstituted heteroaryl. In various aspects, wherein X₁, X₂, and X₃ are independently CR₁₃R₁₄, O, NH, substituted alkyl, unsubstituted alkyl, unsubstituted aryl, or substituted aryl unsubstituted aryl, or substituted aryl. In some aspects, wherein X₁, X₂, and X₃ are independently CR₁₃R₁₄, O, NH, unsubstituted aryl, or substituted aryl.

Generally, R₁, R₂, R₃, R₄, R₅, R₆, R₁₀, R₁₁, and R₁₂ are independently hydrogen, substituted C₁-C₁₀ alkyl, unsubstituted C₁-C₁₀ alkyl, substituted C₁-C₁₀ alkenyl, unsubstituted C₁-C₁₀ alkenyl, substituted C₁-C₁₀ alkoxy, unsubstituted C₁-C₁₀ alkoxy, substituted C₁-C₁₀ alkynyl, or unsubstituted C₁-C₁₀ alkynyl. In various aspects, R₁, R₂, R₃, R₄, R₅, and R₆ are independently hydrogen, substituted C₁-C₆ alkyl, unsubstituted C₁-C₆ alkyl, substituted C₁-C₆ alkenyl, unsubstituted C₁-C₆ alkenyl, substituted C₁-C₆ alkoxy, unsubstituted C₁-C₆ alkoxy, substituted C₁-C₆ alkynyl, or unsubstituted C₁-C₆ alkynyl. In some aspects, R₁, R₂, R₃, R₄, R₅, and R₆ are independently hydrogen, methyl, ethyl, propyl, isopropyl, benzyl, ethylene, propylene, or phenyl.

Generally, R₇, R₈, or R₉ are independently absent or selected from a group consisting of hydrogen, substituted C₁-C₁₀ alkyl, unsubstituted C₁-C₁₀ alkyl, substituted C₄-C₈ cycloalkyl, unsubstituted C₄-C₈ cycloalkyl, substituted C₁-C₁₀ alkenyl, unsubstituted C₁-C₁₀ alkenyl, substituted C₄-C₈ cycloalkenyl, unsubstituted C₄-C₈ cycloalkenyl, substituted C₁-C₁₀ alkynyl, unsubstituted C₁-C₁₀ alkynyl; substituted aryl, unsubstituted aryl, substituted heteroaryl, and unsubstituted heteroaryl. In various aspects, R₇, R₈, or R₉ are independently absent or selected from a group consisting of hydrogen, substituted C₁-C₆ alkyl, unsubstituted C₁-C₆ alkyl, substituted C₅-C₇ cycloalkyl, unsubstituted C₅-C₇ cycloalkyl, substituted C₁-C₆ alkenyl, unsubstituted C₁-C₆ alkenyl, substituted C₅-C₇ cycloalkenyl, unsubstituted C₅-C₇ cycloalkenyl, substituted C₁-C₆ alkynyl, unsubstituted C₁-C₆ alkynyl; substituted aryl, unsubstituted aryl, substituted heteroaryl, and unsubstituted heteroaryl. In some aspects, R₇, R₈, or R₉ are independently absent or selected from a group consisting of hydrogen, methyl, ethyl, propyl, isopropyl, benzyl, hexafluoroiso-propyl, 1H, 1H, 3H, hexafluorobutyl, 1H, 1H, 7H-dodecafluoroheptyl, 2,2,2-trifluoroethyl, 1H, 1H, 2H, 2H-heptafluorodecyl, 1H, 1H, 5H-octafluorodecyl, phenyl, 4-hydroxyphenyl, 4-hydroxy-3-ethylphenyl, 4 fluorophenyl, pentafluorophenyl, 2-hydroxyethyl, 3-hydroxypropyl, 2-aminoethyl, 3-aminopropyl; 2-carboxyethyl, 3 carboxypropyl, phenyl, naphthalene, anthracene, phenanthrene, bi-phenyl, phenalene, and cyclopentadienyl.

In general, R₁₃, R₁₄, and R₁₅ are independently hydrogen, substituted C₁-C₁₀ alkyl, unsubstituted C₁-C₁₀ alkyl, substituted C₄-C₈ cycloalkyl, unsubstituted C₄-C₈ cycloalkyl, substituted C₁-C₁₀ alkenyl, unsubstituted C₁-C₁₀ alkenyl, substituted C₄-C₈ cycloalkenyl, unsubstituted C₄-C₈ cycloalkenyl, substituted C₁-C₁₀ alkynyl, unsubstituted C₁-C₁₀ alkynyl; substituted aryl, unsubstituted aryl, substituted heteroaryl, or unsubstituted heteroaryl. In various aspects, R₁₃, R₁₄, and R₁₅ are independently hydrogen, substituted C₁-C₆ alkyl, unsubstituted C₁-C₆ alkyl, substituted C₅-C₇ cycloalkyl, unsubstituted C₅-C₇ cycloalkyl, substituted C₁-C₆ alkenyl, unsubstituted C₁-C₆ alkenyl, substituted C₅-C₇ cycloalkenyl, unsubstituted C₅-C₇ cycloalkenyl, substituted C₁-C₆ alkynyl, unsubstituted C₁-C₆ alkynyl; substituted aryl, unsubstituted aryl, substituted heteroaryl, or unsubstituted heteroaryl. In some aspects, R₁₃, R₁₄, and R₁₅ are independently hydrogen, methyl, ethyl, isopropyl, or propyl.

In general, the random multi-component polymer comprising Formula (I) ranges about 50 weight percent (50 wt %) to about 99.8 wt %. In various aspects, the random multi-component polymer comprising Formula (I) ranges about 50 weight percent (50 wt %) to about 99.8 wt %, from about 60 wt % to about 95 wt %, from about 65 wt % to about 80 wt %, or from about 70 wt % to about 75 wt %.

Generally, the random multi-component polymer comprising Formula (II) ranges from about 0 wt % to about 50 wt %. In various aspects, the random multi-component polymer of Formula (II) ranges from about 0 wt % to about 50 wt %, from about 1 wt % to about 45 wt %, from about 5 wt % to about 40 wt %, from about 10 wt % to 30 wt %, or from about 20 wt % to about 25 wt %.

In general, the random multi-component polymer comprising Formula (III) ranges from about 0 wt % to about 50 wt %. In various aspects, the random multi-component polymer of Formula (III) ranges from about 0 wt % to about 50 wt %, from about 1 wt % to about 45 wt %, from about 5 wt % to about 40 wt %, from about 10 wt % to 30 wt %, or from about 20 wt % to about 25 wt %.

Each component of the random multi-component polymer imparts specific properties to the random multi-component polymer. The compound of Formula (I) imparts the temperature responsiveness termed LCST (low critical solution temperature). The compound of Formula (II) imparts inter-association between the polymer chain which leads to enhanced flocculation behavior. The compound of Formula (III) imparts affinity for specific soluble species (i.e., cationic monomers to attract anionic compounds).

The random multi-component polymer is hydrophilic in character which indicates the random multi-component polymer is miscible or partially miscible in an aqueous solution or combinations of an aqueous solution and an organic solvent.

The random multi-component polymer exhibits a lower critical solution temperature range from about 0° C. to about 50° C., at atmospheric pressure. In various aspects, the lower critical solution temperature ranges from about 0° C. to about 50° C., from about 10° C. to about 40° C., from about 20° C. to about 40° C., or from about 22° C. to about 27° C. In one aspect, the lower critical solution temperature is about 25° C. or about room temperature.

### (III) Processes for Preparing Random Multi-Component Polymers Comprising the Compound of Formula (I), the Compound of Formula (II), and the Compound of Formula (III)

Another aspect of the disclosure provides processes for preparing the random multi-component polymer comprising Formula (I), Formula (II), and Formula (III) or a salt thereof. The processes comprise contacting the compound of Formula (I) with the compound of Formula (II) and the compound of Formula (III) to form a random copolymer according to the following reaction scheme:

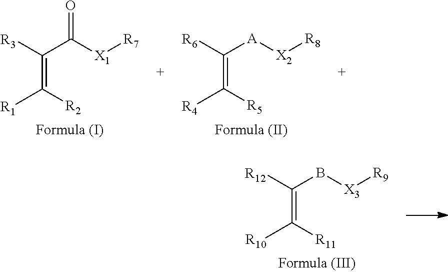

Generally, A and B are independently —CH₂— or C(═O). In various aspects, A and B are independently —CH₂— or C(═O).

In general, X₁, X₂, and X₃ are independently CR₁₃R₁₄, O, NR₁₅, NH, S, substituted aryl, unsubstituted aryl, substituted heteroaryl, or unsubstituted heteroaryl. In various aspects, wherein X₁, X₂, and X₃ are independently CR₁₃R₁₄, O, NH, substituted alkyl, unsubstituted alkyl, unsubstituted aryl, or substituted aryl unsubstituted aryl, or substituted aryl. In some aspects, wherein X₁, X₂, and X₃ are independently CR₁₃R₁₄, O, NH, unsubstituted aryl, or substituted aryl.

Generally, R₁, R₂, R₃, R₄, R₅, R₆, R₁₀, R₁₁, and R₁₂ are independently hydrogen, substituted C₁-C₁₀ alkyl, unsubstituted C₁-C₁₀ alkyl, substituted C₁-C₁₀ alkenyl, unsubstituted C₁-C₁₀ alkenyl, substituted C₁-C₁₀ alkoxy, unsubstituted C₁-C₁₀ alkoxy, substituted C₁-C₁₀ alkynyl, or unsubstituted C₁-C₁₀ alkynyl. In various aspects, R₁, R₂, R₃, R₄, R₅, and R₆ are independently hydrogen, substituted C₁-C₆ alkyl, unsubstituted C₁-C₆ alkyl, substituted C₁-C₆ alkenyl, unsubstituted C₁-C₆ alkenyl, substituted C₁-C₆ alkoxy, unsubstituted C₁-C₆ alkoxy, or substituted C₁-C₆ alkynyl, or unsubstituted C₁-C₆ alkynyl. In some aspects, R₁, R₂, R₃, R₄, R₅, and R₆ are independently hydrogen, methyl, ethyl, propyl, isopropyl, benzyl, ethylene, propylene, or phenyl.

Generally, R₇, R₈, or R₉ are independently absent or selected from a group consisting of hydrogen, substituted C₁-C₁₀ alkyl, unsubstituted C₁-C₁₀ alkyl, substituted C₄-C₈ cycloalkyl, unsubstituted C₄-C₈ cycloalkyl, substituted C₁-C₁₀ alkenyl, unsubstituted C₁-C₁₀ alkenyl, substituted C₄-C₈ cycloalkenyl, unsubstituted C₄-C₈ cycloalkenyl, substituted C₁-C₁₀ alkynyl, unsubstituted C₁-C₁₀ alkynyl; substituted aryl, unsubstituted aryl, substituted heteroaryl, and unsubstituted heteroaryl. In various aspects, R₇, R₈, or R₉ are independently absent or selected from a group consisting of hydrogen, substituted C₁-C₆ alkyl, unsubstituted C₁-C₆ alkyl, substituted C₅-C₇ cycloalkyl, unsubstituted C₅-C₇ cycloalkyl, substituted C₁-C₆ alkenyl, unsubstituted C₁-C₆ alkenyl, substituted C₅-C₇ cycloalkenyl, unsubstituted C₅-C₇ cycloalkenyl, substituted C₁-C₆ alkynyl, unsubstituted C₁-C₆ alkynyl; substituted aryl, unsubstituted aryl, substituted heteroaryl, and unsubstituted heteroaryl. In some aspects, R₇, R₈, or R₉ are independently absent or selected from a group consisting of hydrogen, methyl, ethyl, propyl, isopropyl, benzyl, hexafluoroiso-propyl, 1H, 1H, 3H, hexafluorobutyl, 1H, 1H, 7H-dodecafluoroheptyl, 2,2,2-trifluoroethyl, 1H, 1H, 2H, 2H-heptafluorodecyl, 1H, 1H, 5H-octafluorodecyl, phenyl, 4-hydroxyphenyl, 4-hydroxy-3-ethylphenyl, 4 fluorophenyl, pentafluorophenyl, 2-hydroxyethyl, 3-hydroxypropyl, 2-aminoethyl, 3-aminopropyl; 2-carboxyethyl, 3 carboxypropyl, phenyl, naphthalene, anthracene, phenanthrene, bi-phenyl, phenalene, and cyclopentadienyl.

In general, R₁₃, R₁₄, and R₁₅ are independently hydrogen, substituted C₁-C₁₀ alkyl, unsubstituted C₁-C₁₀ alkyl, substituted C₄-C₈ cycloalkyl, unsubstituted C₄-C₈ cycloalkyl, substituted C₁-C₁₀ alkenyl, unsubstituted C₁-C₁₀ alkenyl, substituted C₄-C₈ cycloalkenyl, unsubstituted C₄-C₈ cycloalkenyl, substituted C₁-C₁₀ alkynyl, unsubstituted C₁-C₁₀ alkynyl; substituted aryl, unsubstituted aryl, substituted heteroaryl, or unsubstituted heteroaryl. In various aspects, R₁₃, R₁₄, and R₁₅ are independently hydrogen, substituted C₁-C₆ alkyl, unsubstituted C₁-C₆ alkyl, substituted C₅-C₇ cycloalkyl, unsubstituted C₅-C₇ cycloalkyl, substituted C₁-C₆ alkenyl, unsubstituted C₁-C₁₀ alkenyl, substituted C₁-C₆ alkenyl, unsubstituted C₁-C₆ alkenyl, substituted C₅-C₇ cycloalkenyl, unsubstituted C₅-C₇ cycloalkenyl, substituted C₁-C₆ alkynyl, unsubstituted C₁-C₆ alkynyl; substituted aryl, unsubstituted aryl, substituted heteroaryl, or unsubstituted heteroaryl. In some aspects, R₁₃, R₁₄, and R₁₅ are independently hydrogen, methyl, ethyl, isopropyl, or propyl.

### (a) Compound of Formula (I)

The compound of Formula (I) is described above. In various aspects, X₁, X₂, and X₃ are independently CR₁₃R₁₄, O, NH, unsubstituted aryl, or substituted aryl; R₁, R₂, R₃, are independently hydrogen, methyl, ethyl, propyl, isopropyl, benzyl, ethylene, propylene, or phenyl; and R₇, is absent or selected from a group consisting of hydrogen, methyl, ethyl, propyl, isopropyl, benzyl, hexafluoroiso-propyl, 1H, 1H, 3H, hexafluorobutyl, 1H, 1H, 7H-dodecafluoroheptyl, 2,2,2-trifluoroethyl, 1H, 1H, 2H, 2H-heptafluorodecyl, 1H, 1H, 5H-octafluorodecyl, phenyl, 4-hydroxyphenyl, 4-hydroxy-3-ethylphenyl, 4 fluorophenyl, pentafluorophenyl, 2-hydroxyethyl, 3-hydroxypropyl, 2-aminoethyl, 3-aminopropyl; 2-carboxyethyl, 3 carboxypropyl, phenyl, naphthalene, anthracene, phenanthrene, bi-phenyl, phenalene, and cyclopentadienyl.

Generally, the random multi-component polymer comprising Formula (I) ranges from about 50 wt % to about 99.8 wt %. In various aspects, the random multi-component polymer comprising Formula (I) ranges about 50 weight percent (50 wt %) to about 99.8 wt %, from about 60 wt % to about 95 wt %, from about 65 wt % to about 80 wt %, or from about 70 wt % to about 75 wt %.

### (b) Compound of Formula (II)

The compound of Formula (II) is described above. In various aspects, A is —CH₂— or C(═O); X₂, is CR₁₃R₁₄, O, NH, unsubstituted aryl, or substituted aryl; R₄, R₅, and R₆ are independently hydrogen, methyl, ethyl, propyl, isopropyl, benzyl, ethylene, propylene, or phenyl; and R₈, is absent or selected from a group consisting of hydrogen, methyl, ethyl, propyl, isopropyl, benzyl, hexafluoroiso-propyl, 1H, 1H, 3H, hexafluorobutyl, 1H, 1H, 7H-dodecafluoroheptyl, 2,2,2-trifluoroethyl, 1H, 1H, 2H, 2H-heptafluorodecyl, 1H, 1H, 5H-octafluorodecyl, phenyl, 4-hydroxyphenyl, 4-hydroxy-3-ethylphenyl, 4 fluorophenyl, pentafluorophenyl, 2-hydroxyethyl, 3-hydroxypropyl, 2-aminoethyl, 3-aminopropyl; 2-carboxyethyl, 3 carboxypropyl, phenyl, naphthalene, anthracene, phenanthrene, bi-phenyl, phenalene, and cyclopentadienyl.

In general, the random multi-component polymer comprising Formula (II) ranges from about 0 wt % to about 50 wt %. In various aspects, the random multi-component polymer of Formula (II) ranges from about 0 wt % to about 50 wt %, from about 1 wt % to about 45 wt %, from about 5 wt % to about 40 wt %, from about 10 wt % to 30 wt %, or from about 20 wt % to about 25 wt %.

### (c) Compound of Formula (III)

The compound of Formula (III) is described above. In various aspects, B is —CH₂— or C(═O); X₃, is CR₁₃R₁₄, O, NH, unsubstituted aryl, or substituted aryl; R₁₀, R₁₁, and R₁₂ are independently hydrogen, methyl, ethyl, propyl, isopropyl, benzyl, ethylene, propylene, or phenyl; and R₉ is absent or selected from a group consisting of hydrogen, methyl, ethyl, propyl, isopropyl, benzyl, hexafluoroiso-propyl, 1H, 1H, 3H, hexafluorobutyl, 1H, 1H, 7H-dodecafluoroheptyl, 2,2,2-trifluoroethyl, 1H, 1H, 2H, 2H-heptafluorodecyl, 1H, 1H, 5H-octafluorodecyl, phenyl, 4-hydroxyphenyl, 4-hydroxy-3-ethylphenyl, 4-fluorophenyl, pentafluorophenyl, 2-hydroxyethyl, 3-hydroxypropyl, 2-aminoethyl, 3-aminopropyl; 2-carboxyethyl, 3 carboxypropyl, phenyl, naphthalene, anthracene, phenanthrene, bi-phenyl, phenalene, and cyclopentadienyl.

In general, the random multi-component polymer comprising Formula (III) ranges from about 0 wt % to about 50 wt %. In various aspects, the random multi-component polymer of Formula (III) ranges from about 0 wt % to about 50 wt %, from about 1 wt % to about 45 wt %, from about 5 wt % to about 40 wt %, from about 10 wt % to 30 wt %, or from about 20 wt % to about 25 wt %.

### (d) Free Radical Polymerization Initiator

The process may further comprise a free radical polymerization initiator. Generally, the free radical polymerization initiator is selected from a group consisting of an azo compound, an organic peroxide, an inorganic peroxide, ultraviolet light, and any combinations thereof. Non-limiting examples of free radical polymerization initiators may be azobisisobutyronitrile; di-tert-butylperoxide; tert-butyl peracetate; tert-butyl peroxide; methyl ethyl ketone peroxide; acetone peroxide; cyclohexane peroxide; 2,4-pentanedione peroxide; ammonium persulfate; potassium persulfate; ultraviolet light, or combinations thereof.

Generally, the free radical polymerization initiator used in the process may range from about 0.01 wt % to about 1.0 wt %. In various aspects, the free radical polymerization initiator used in the process may range from about 0.01 wt % to about 1.0 wt %, from about 0.05 wt % to about 0.5 wt %, or from about 0.075 wt % to about 0.125 wt %.

### (e) Solvent

The process, as detailed herein, may also comprise a solvent. The solvent can and will vary depending on the starting substrates used in the process. The solvent may be a polar protic solvent, a polar aprotic solvent, a non-polar solvent, or combinations thereof. Suitable examples of polar protic solvents include, but are not limited to, water; alcohols such as methanol, ethanol, isopropanol, n-propanol, isobutanol, n-butanol, s-butanol, t-butanol, and the like; diols such as ethylene glycol, propylene glycol; polyols such as glycerol, mannitol, sorbitol; organic acids such as formic acid, acetic acid, and so forth; amines such as trimethylamine, or triethylamine, and the like; amides such as formamide, acetamide, and so forth; and combinations of any of the above. Non-limiting examples of suitable polar aprotic solvents include acetonitrile, dichloromethane (DCM), diethoxymethane, N,N-dimethylacetamide (DMAC), N,N-dimethylformamide (DMF), dimethyl sulfoxide (DMSO), N,N-dimethylpropionamide, 1,3-dimethyl-3,4,5,6-tetrahydro-2(1H)-pyrimidinone (DMPU), 1,3-dimethyl-2-imidazolidinone (DMI), 1,2-dimethoxyethane (DME), dimethoxymethane, bis(2-methoxyethyl)ether, 1,4-dioxane, N-methyl-2-pyrrolidinone (NMP), ethyl formate, formamide, hexamethylphosphoramide, N-methylacetamide, N-methylformamide, methylene chloride, nitrobenzene, nitromethane, propionitrile, sulfolane, tetramethylurea, tetrahydrofuran (THF), 2-methyltetrahydrofuran, trichloromethane, and combinations thereof. Suitable examples of non-polar solvents include, but are not limited to, alkane and substituted alkane solvents (including cycloalkanes), aromatic hydrocarbons, esters, ethers, combinations thereof, and the like. Specific non-polar solvents that may be employed include, for example, benzene, butyl acetate, t-butyl methylether, chlorobenzene, chloroform, chloromethane, cyclohexane, dichloromethane, dichloroethane, diethyl ether, ethyl acetate, diethylene glycol, fluorobenzene, heptane, hexane, isopropyl acetate, methyltetrahydrofuran, pentyl acetate, n-propyl acetate, tetrahydrofuran, toluene, and combinations thereof. In an aspect, the solvent comprises dimethylsulfoxide and water.

### (f) Reaction Conditions

In general, there are many methods to stir the contents of the process. Non-limiting methods for stirring these processes are magnetic or mechanical.

In general, the process will be conducted at a temperature that ranges from about 25° C. to about 125° C. In various aspects, the temperature of the reaction may range from about 25° C. to about 125° C., from about 30° C. to about 120° C., from about 40° C. to about 100° C., or from about 50° C. to about 90° C. In one aspect, the reaction may be conducted at temperature that ranges from about 30° C. to about 90° C. The reaction typically is performed under ambient pressure. The reaction may also be purged and conducted under an inert atmosphere, for example under nitrogen, argon or helium.

Generally, the reaction is allowed to proceed for a sufficient period of time until the reaction is complete, as determined by any method known to one skilled in the art, such as chromatography (e.g., HPLC or TLC) by analyzing one of the residual monomers in solution.

The duration of the reaction can and will vary depending many factors, such as the compounds of Formula (I), the compound of Formula (II), the compound of Formula (III), and the solvent of the reaction. The duration of the reaction may range from about 5 minutes to about 12 hours. In some aspects, the duration of the reaction may range from about 5 minutes to about 30 minutes, from about 30 minutes to about 2 hours, from about 2 hours to about 4 hours, from about 4 hours to about 10 hours, or from about 10 hours to about 12 hours. In this context, a “completed reaction” generally means that the reaction mixture contains a significantly diminished amount of the compound of Formula (I) and compound of Formula (II). Typically, the amount of the compound of Formula (I) and compound of Formula (II) remaining in the reaction mixture at the end of the reaction may be less than about 10%, less than about 5%, or less than about 2%.

### (g) Isolation of the Random Multi-Component Polymer Comprising Compound of Formula (I), Compound of Formula (II), and Compound of Formula (III)

With the water miscibility of the random multi-component polymer, various methods can be utilized to isolate the random multi-component polymer. Non-limiting examples of methods of isolation may be spray drying, precipitation of the random multi-component polymer using water or a salt solution, evaporation of the solvent and excess monomers present, or lyophilization (freeze drying). The crude sticky random multi-component polymer is then washed with water and then dried under vacuum.

The random multi-component polymer comprising compound of Formula (I), compound of Formula (II), and compound of Formula (III) may have a yield of at least about 50%. In various aspects, the random multi-component polymer comprising compound of Formula (I), compound of Formula (II), and compound of Formula (III) may have a yield of at least about 50%, a yield of at least about 60%, at least about 70%, at least about 75%, at least about 80%, at least about 85%, at least about 90%, at least about 95%, or at least about 99%.

### (IV) Methods for Utilizing the Random Multi-Component Polymers Comprising the Compound of Formula (I), Compound of Formula (II), and Compound of Formula (III)

Still another aspect of the present disclosure encompasses method for removing soluble species or insoluble particles from an aqueous solution. The method comprising: (a) providing an aqueous solution comprising soluble species or insoluble particles; (b) treating the aqueous solution comprising the soluble species or the insoluble particles with the random multi-component polymer at room temperature forming a first reaction mixture; (c) stirring the first reaction mixture of the aqueous solution comprising soluble species or the insoluble particles and the random multi-component polymer; (d) heating the first reaction mixture from step (c) above the lower critical solution temperature of the random multi-component polymer thereby promoting the random multi-component polymer to flocculate the soluble species or the insoluble particles; and (e) separating the flocculated particle from step (d). The method further comprises deflocculating the particle from step (e) and isolating the random multi-component polymer and the solid particles. This deflocculating method comprising: (f) suspending the flocculated particle from step (e) in water or a combination of water and an organic solvent; (g) lowering the temperature below the lower critical solution temperature; and (h) separating the random multi-component polymer from the soluble species or the insoluble particles. This method removes a high percentage of the soluble species or insoluble particles from the aqueous solution.

### (a) An Aqueous Solution Comprising Soluble Species or Insoluble Particles

A variety of soluble species or the insoluble particles can be present in an aqueous solution. These soluble species or the insoluble particles generally are suspended in the aqueous solution. The insoluble particles have varied sizes from fine and ultrafine particles (between 100 and 2500 nanometers) to nanoparticles (generally less than 100 nanometers).

A variety of insoluble particles may be present in the aqueous solution. Non-limiting examples of these solids may be metals (such as iron, nickel, copper, zinc, silver), metal oxides (such as Fe₃O₄, TiO₂, ZnO, CeO₂), metal oxide nanoparticles (MONP), clay, silica, kaolinite, alumina, oil, organic compounds, humic matter, or combinations thereof. The concentration of these solid particles can and will vary depending on the type of aqueous solution provided.

A variety of soluble species may be present in the aqueous solution. Non-limiting examples of these soluble species may be soluble species during water treatment, environmental contaminants with low or high solubility during water clarification, per- and polyfluoroalkyl substances (PFAS) or other environmental contaminants from groundwater, drinking water, wastewater, landfill leachate, reverse osmosis concentrate, or ion exchange brine.

(b) Treating the Aqueous Solution Comprising Soluble Species or the Insoluble Particles with the Random Multi-Component Polymer at Room Temperature Forming a First Reaction Mixture

The aqueous solution from step (a) is treated with the random multi-component polymer. Random multi-component polymers are described in more detail above in Section (I).

The amount of random multi-component polymer added to the aqueous solution comprising soluble species or the insoluble particles can and will vary depending on the amount of soluble species or the insoluble particles, the type of soluble species or the insoluble particles, the concentration of the soluble species or the insoluble particles, the type of aqueous solution, and the amount of removal of the soluble species or the insoluble particles. In general, the weight of random multi-component polymer is generally greater than the amount the soluble species or the insoluble particles present. If less random multi-component polymer is used, a concentration of the soluble species or the insoluble particles would remain in the aqueous solution.

(c) Stirring the First Reaction Mixture of the Aqueous Solution Comprising Soluble Species or the Insoluble Particles with the Random Multi-Component Polymer

In order to provide efficiency of the flocculation, the soluble species or the insoluble particles in the first reaction mixture are mixed with random multi-component polymer to provide a well dispersed mixture. The soluble species or the insoluble particles are attracted to the random multi-component polymer through ionic interaction. Various methods of stirring these mixtures are known in the art.

(d) Heating the First Reaction Mixture from Step (c) Above the Lower Critical Solution Temperature of the Random Multi-Component Polymer Thereby Promoting the Random Multi-Component Polymer to Flocculate the Soluble Species or the Insoluble Particles

The lower critical solution temperature (LCST) is the critical temperature below which the components of a mixture are miscible or partially miscible in water. Upon heating the mixture of the soluble species or the insoluble particles and the random multi-component polymer above the LCST, a phase transition occurs where the hydrophilic groups aggregate around the soluble species or the insoluble particles causing the random multi-component polymer to flocculate and resulting exterior surface of the aggregated random multi-component polymer to become hydrophobic. This phase transition additionally expels water and the flocculated particle now precipitates from the aqueous solution.

Generally, the lower critical solution temperature ranges from about 0° C. to about 100° C. In various aspects, the lower critical solution temperature ranges from about 0° C. to about 100° C., from about 25° C. to about 75° C., or from about 40° C. to about 60° C. In one preferred aspect, the lower critical solution temperature is about 50° C.

The duration to flocculate the random multi-component polymer and the soluble species or the insoluble particles can and will vary depending on the random multi-component polymer used, the specific soluble species or insoluble particles, and the concentration of the soluble species or insoluble particles. Generally, the duration of flocculation may range from 1 second to 12 hours. In various embodiment, the duration of flocculation may range from 1 second to 12 hours, from about 1 minute to about 6 hours, or from 30 minutes to 2 hours.

(e) Separating the Flocculated Particle from Step (d)

Since the flocculated particle precipitates from the aqueous solution, the flocculated particle is easily separated from the aqueous solution. Method of separating precipitates is well known in the arts.

Generally, the flocculation of the random multi-component polymer around the solid particles removes at least 50% of the solid particles from the aqueous solution. In various aspects, the amount of the solid particles removed from the aqueous solution is at least 50%, at least 75%, or at least 95%.

The method described above further comprises deflocculating the particle from step (e) above and isolating the random multi-component polymer and the solid particles. The method comprises: (f) suspending the flocculated particle from step (e) in water, a solvent, or combinations thereof; (g) lowering the temperature below the lower critical solution temperature of the mixture from step (f); and separating the random multi-component polymer from the soluble species or the insoluble particles.

(V) Methods of Removing Soluble Species or Insoluble Particles from an Aqueous Solution in a Human Body or a Mammal Body Utilizing the Random Multi-Component Polymers Comprising the Compound of Formula (I), Compound of Formula (II), and Compound of Formula (III)

Still yet another aspect of the present disclosure encompasses methods of removing soluble species or insoluble particles from an aqueous solution in a human body or a mammal body. The methods comprise: (a) providing an aqueous solution comprising soluble species or insoluble particles in the human body; (b) treating the aqueous solution comprising the soluble species or the insoluble particles with a solution of the random multi-component polymer of claim 1 at room temperature to form a mixture in the body; (c) potentially providing mixing (rubbing, swishing, etc.) to the mixture of the aqueous solution comprising soluble species or insoluble particles and the random multi-component polymer in the human body; (d) allowing the body temperature to heat the mixture from step (c) above a lower critical solution temperature of the random multi-component polymer thereby promoting the random multi-component polymer to form a flocculated material; and (e) removing the flocculated material from step (d).

### (a) Providing an Aqueous Solution Comprising Soluble Species or Insoluble Particles in a Human Body or a Mammal Body

A suitable subject includes a human or a mammal such as a livestock animal, a companion animal, a lab animal, or a zoological animal. In one embodiment, the mammal may be a rodent, e.g., a mouse, a rat, a guinea pig, etc. In another embodiment, the mammal may be a livestock animal. Non-limiting examples of suitable livestock animals may include pigs, cows, horses, goats, sheep, llamas and alpacas. In yet another embodiment, the mammal may be a companion animal. Non-limiting examples of companion animals may include pets such as dogs, cats, rabbits, and birds. In yet another embodiment, the mammal may be a zoological animal. As used herein, a “zoological animal” refers to an animal that may be found in a zoo. Such animals may include non-human primates, large cats, wolves, and bears. In a specific embodiment, the animal is a laboratory animal. Non-limiting examples of a laboratory animal may include rodents, canines, felines, and non-human primates. In certain embodiments, the animal is a rodent. Non-limiting examples of rodents may include mice, rats, guinea pigs, etc. In preferred embodiments, the subject is a human.

A variety of soluble species or the insoluble particles can be present in an aqueous solution in the human body or the mammal body. Non-limiting examples of the aqueous solutions may be blood, blood plasma, ocular fluid, mucosal fluids, perspiration, urine, vaginal fluid, spinal fluid, nasal fluids, breast milk, and saliva. These soluble species or the insoluble particles generally are suspended in the aqueous solution in the human body or a mammal body. The insoluble particles have varied sizes from fine and ultrafine particles (between 100 and 2500 nanometers) to nanoparticles (generally less than 100 nanometers).

A variety of insoluble particles may be present in the aqueous solution. Non-limiting examples of these solids may be viral particles, sand, dust, metals (such as lead, or iron), metal oxides (such as Fe₃O₄, TiO₂, ZnO, CeO₂), metal oxide nanoparticles (MONP), clay, silica, kaolinite, alumina, humic matter, or combinations thereof. The concentration of these insoluble particles can and will vary depending on the type of aqueous solution provided in the human body.

A variety of soluble species may be present in the aqueous solution. Non-limiting examples of these soluble species may be organic compounds such as per- and polyfluoroalkyl substances (PFAS), any environmental contaminant in water or air, intoxicants, allergens, and alkaloids (such as capsaicin).

(b) Treating the Aqueous Solution Comprising the Soluble Species or the Insoluble Particles with a Solution of the Random Multi-Component Polymer of Claim 1 at Room Temperature to Form a Mixture in the Human Body or the Mammal Body

The aqueous solution from step (a) is treated with the random multi-component polymer. Random multi-component polymers are described in more detail above in Section (I).

The amount of random multi-component polymer added to the aqueous solution comprising soluble species or the insoluble particles in the human body can and will vary depending on the amount of soluble species or the insoluble particles, the type of soluble species or the insoluble particles, the concentration of the soluble species or the insoluble particles, the specific type of aqueous solution in the human body, and the amount of removal of the soluble species or the insoluble particles. In general, the weight of random multi-component polymer is generally greater than the amount the soluble species or the insoluble particles present. If less random multi-component polymer is used, a concentration of the soluble species or the insoluble particles would remain in the aqueous solution.

Non-limiting examples of treating the aqueous solution comprising the soluble species or the insoluble particles with a solution of the random multi-component polymer of claim 1 at room temperature to form a mixture in the human body may be intravenous injection, subcutaneous injection, spinal injection, cranial injection, or introduction into the nasal passage, eye surface, skin surface, vaginal cavity, or oral cavity.

### (c) Potentially Providing Mixing (Rubbing, Swishing, Etc.) to the Mixture of the Aqueous Solution Comprising Soluble Species or Insoluble Particles and the Random Multi-Component Polymer in the Human Body or the Mammal Body

The next step in the method, Step (c), potentially providing mixing to the mixture of the aqueous solution comprising soluble species or insoluble particles and the random multi-component polymer in the human body or the mammal body. Non-limiting examples of potentially providing mixing may be rubbing, swishing, or the circulation through the blood stream would provide sufficient mixing to contact the random multi-component polymer and the soluble species or the insoluble particles. Other methods of potentially providing mixing are known in the art.

(d) Allowing the Body Temperature to Heat the Mixture from Step (c) Above a Lower Critical Solution Temperature of the Random Multi-Component Polymer Thereby Promoting the Random Multi-Component Polymer to Form a Flocculated Material

The next step in the method, step (d), warms the mixture of the random multi-component polymer and the soluble and insoluble particles above a lower critical solution temperature of the random multi-component polymer thereby promoting the random multi-component polymer to form a flocculated material. Since the aqueous solution of the random multi-component polymer is introduced into the human body, the temperature of the human body ˜37° C. (98.6° F.) is sufficient to promote the random multi-component polymer to flocculate the soluble and insoluble particles.

The duration to flocculate the random multi-component polymer and the soluble species or the insoluble particles in the human body or the mammal body can and will vary depending on the random multi-component polymer used, the specific soluble species or insoluble particles in the in the human body or the mammal body, the specific aqueous solution in the human body or the mammal body, and the concentration of the soluble species or insoluble particles in the human body or the mammal body. Generally, the duration of flocculation may range from 1 second to 3 hours. In various embodiment, the duration of flocculation may range from 1 second to 3 hours, from about 1 minute to about 2 hours, or from 30 minutes to 1 hour.

(e) Removing the Flocculated Material from Step (d)

The last step, step (e), in the method is (e) removing the flocculated material from step (d). Various methods are known in the art to accomplish this removal. For example, for eyes, drops are added to eye. The eyes begin to water (tear) and the flocculant material would be removed with the tears. For nasal administration for example, a nose spray is administered, and the nose is blown out remove the flocculated material. For the mouth for example, a mouth rinse is used. The mouth is rinsed (and swished) and the mouth rinse is then spit out (expelled) with the flocculated material. Additional mouth rinse can be added to fully remove the flocculated material. For other surface or accessible cavities for example, one or more rinse steps could be used. For blood for example, blood can be removed from the human body or the mammal body, filtered (using a dialysis-type procedure) to remove the flocculated material, and returned to the human body or the mammal body.

### Definitions

When introducing elements of the embodiments described herein, the articles “a”, “an”, “the” and “said” are intended to mean that there are one or more of the elements. The terms “comprising”, “including” and “having” are intended to be inclusive and mean that there may be additional elements other than the listed elements.

The term “alkyl” as used herein describes groups which are preferably lower alkyl containing from one to eight carbon atoms in the principal chain and up to 20 carbon atoms. They may be straight or branched chain or cyclic and include methyl, ethyl, propyl, isopropyl, butyl, hexyl and the like.

The terms “halogen” or “halo” as used herein alone or as part of another group refer to chlorine, bromine, fluorine, and iodine.

The term “heteroatom” refers to atoms other than carbon and hydrogen.

The term “heteroaromatic” as used herein alone or as part of another group denotes optionally substituted aromatic groups having at least one heteroatom in at least one ring, and preferably 5 or 6 atoms in each ring. The heteroaromatic group preferably has 1 or 2 oxygen atoms, 1 or 2 sulfur atoms, and/or 1 to 4 nitrogen atoms in the ring, and is bonded to the remainder of the molecule through a carbon. Exemplary groups include furyl, benzofuryl, oxazolyl, isoxazolyl, oxadiazolyl, benzoxazolyl, benzoxadiazolyl, pyrrolyl, pyrazolyl, imidazolyl, triazolyl, tetrazolyl, pyridyl, pyrimidyl, pyrazinyl, pyridazinyl, indolyl, isoindolyl, indolizinyl, benzimidazolyl, indazolyl, benzotriazolyl, tetrazolopyridazinyl, carbazolyl, purinyl, quinolinyl, isoquinolinyl, imidazopyridyl, and the like. Exemplary substituents include one or more of the following groups: hydrocarbyl, substituted hydrocarbyl, alkyl, alkoxy, acyl, acyloxy, alkenyl, alkenoxy, aryl, aryloxy, amino, amido, acetal, carbamyl, carbocyclo, cyano, ester, ether, halogen, heterocyclo, hydroxy, keto, ketal, phospho, nitro, and thio.

The terms “heterocyclo” or “heterocyclic” as used herein alone or as part of another group denote optionally substituted, fully saturated or unsaturated, monocyclic or bicyclic, aromatic or non-aromatic groups having at least one heteroatom in at least one ring, and preferably 5 or 6 atoms in each ring. The heterocyclo group preferably has 1 or 2 oxygen atoms, 1 or 2 sulfur atoms, and/or 1 to 4 nitrogen atoms in the ring, and is bonded to the remainder of the molecule through a carbon or heteroatom. Exemplary heterocyclo groups include heteroaromatics as described above. Exemplary substituents include one or more of the following groups: hydrocarbyl, substituted hydrocarbyl, alkyl, alkoxy, acyl, acyloxy, alkenyl, alkenoxy, aryl, aryloxy, amino, amido, acetal, carbamyl, carbocyclo, cyano, ester, ether, halogen, heterocyclo, hydroxy, keto, ketal, phospho, nitro, and thio.

Having described the invention in detail, it will be apparent that modifications and variations are possible without departing from the scope of the invention defined in the appended claims.

### EXAMPLES

The following examples illustrate various aspects of the invention.

### Example 1: Preparation of Random Multi-Component Polymer of NIPAAm and DMAPAQ

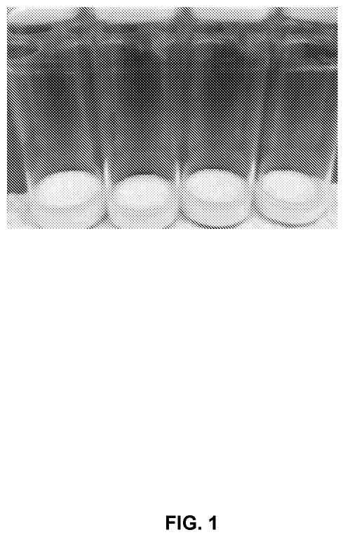

Into a sealed vial may be placed 95 wt % of N-isopropylacrylamide (NIPAAm) and 5 wt % of N-[3-(dimethylamino)propyl] acrylamide, methyl chloride quaternary (DMAPAQ). These materials may be dissolved in DI water and the solution may be mixed for 15 minutes. Then 1 wt % of ammonium persulfate (pre-dissolved in DI water at 0.05 g ml-1) may be added, followed by addition of N,N,N′,N′-tetramethylethylenediamine (TEMED) may be added at 0.1 wt %. The polymerization may be carried out in 20° C. water bath for twenty-four hours. After polymerization the multi-component polymer may be further purified by the following method. The crude product may be washed in DI water (200 ml) to remove unreacted monomer and APS/TEMED. The product is dissolved in DI water and allowed to swell in 4° C. water bath for twenty-four hours. The product may be precipitated with addition of NaCl at elevated temperature (50° C.) to collect the dissolved polymers. This washing process may be repeated for three times, and the final polymer was dried in vacuum for 24 h. The process may yield of the random multi-component polymer. See FIG. 1, vial furthest to left for example of polymer after washing.

### Example 2: Preparation of Random Multi-Component Polymer of NIPAAm and DDHFA

Into a sealed vial may be placed 95 wt % of N-isopropylacrylamide (NIPAAm) and 5 wt % of dodecafluoroheptyl acrylate (DDHFA). These materials may be dissolved in DI water and the solution may be mixed for 15 minutes. Then, 1 wt % of ammonium persulfate (pre-dissolved in DI water at 0.05 g ml-1) may be added, followed by addition of N,N,N′,N′-tetramethylethylenediamine (TEMED) may be added at 0.1 wt %. The polymerization may be carried out in 20° C. water bath for twenty-four hours. After polymerization the multi-component polymer may be further purified by the following method. The crude product may be washed in DI water (200 ml) to remove unreacted monomer and APS/TEMED. The product is dissolved in DI water and allowed to swell in 4° C. water bath for twenty-four hours. The product may be precipitated with addition of NaCl at elevated temperature (50° C.) to collect the dissolved polymers. This washing process may be repeated for three times, and the final polymer was dried in vacuum for 24 h. The process may yield of the random multi-component polymer. See FIG. 1, vial second from left for example of polymer after washing.

### Example 3: Preparation of Random Multi-Component Polymer of NIPAAm, DMAPAQ and DDHFA

Into a sealed vial may be placed 92.5 wt % of N-isopropylacrylamide (NIPAAm), 5 wt % of N-[3-(dimethylamino)propyl] acrylamide, methyl chloride quaternary (DMAPAQ) and 2.5 wt % of dodecafluoroheptyl acrylate (DDHFA). These materials may be dissolved in DI water and the solution may be mixed for 15 minutes. Then 1 wt % of ammonium persulfate (pre-dissolved in DI water at 0.05 g ml-1) may be added, followed by addition of N,N,N′,N′-tetramethylethylenediamine (TEMED) may be added at 0.1 wt %. The polymerization may be carried out in 20° C. water bath for twenty-four hours. After polymerization the multi-component polymer may be further purified by the following method. The crude product may be washed in DI water (200 ml) to remove unreacted monomer and APS/TEMED. The product is dissolved in DI water and allowed to swell in 4° C. water bath for twenty-four hours. The product may be precipitated with addition of NaCl at elevated temperature (50° C.) to collect the dissolved polymers. This washing process may be repeated for three times, and the final polymer was dried in vacuum for 24 h. The process may yield of the random multi-component polymer. See FIG. 1, vial third from left for example of polymer after washing.

### Example 4: Preparation of Random Multi-Component Polymer of NIPAAm and DADMAC

Into a sealed vial may be placed 95 wt % of N-isopropylacrylamide (NIPAAm) and 5 wt % of diallyldimethylammonium chloride (DADMAC). These materials may be dissolved in DI water and the solution may be mixed for 15 minutes. Then 1 wt % of ammonium persulfate (pre-dissolved in DI water at 0.05 g ml-1) may be added, followed by addition of N,N,N′,N′-tetramethylethylenediamine (TEMED) may be added at 0.1 wt %. The polymerization may be carried out in 20° C. water bath for twenty-four hours. After polymerization the multi-component polymer may be further purified by the following method. The crude product may be washed in DI water (200 ml) to remove unreacted monomer and APS/TEMED. The product is dissolved in DI water and allowed to swell in 4° C. water bath for twenty-four hours. The product may be precipitated with addition of NaCl at elevated temperature (50° C.) to collect the dissolved polymers. This washing process may be repeated for three times, and the final polymer was dried in vacuum for 24 h. The process may yield of the random multi-component polymer.

### Example 5: Preparation of Random Multi-Component Polymer of NIPAAm, DADMAC and DDHFA

Into a sealed vial may be placed 92.5 wt % of N-isopropylacrylamide (NIPAAm), 5 wt % of diallyldimethylammonium chloride (DADMAC) and 2.5 wt % of dodecafluoroheptyl acrylate (DDHFA). These materials may be dissolved in DI water and the solution may be mixed for 15 minutes. Then 1 wt % of ammonium persulfate (pre-dissolved in DI water at 0.05 g ml-1) may be added, followed by addition of N,N,N′,N′-tetramethylethylenediamine (TEMED) may be added at 0.1 wt %. The polymerization may be carried out in 20° C. water bath for twenty-four hours. After polymerization the multi-component polymer may be further purified by the following method. The crude product may be washed in DI water (200 ml) to remove unreacted monomer and APS/TEMED. The product is dissolved in DI water and allowed to swell in 4° C. water bath for twenty-four hours. The product may be precipitated with addition of NaCl at elevated temperature (50° C.) to collect the dissolved polymers. This washing process may be repeated for three times, and the final polymer was dried in vacuum for 24 h. The process may yield of the random multi-component polymer. See FIG. 1, vial furthest to the right for example of polymer after washing.

### Example 6: Flocculation Studies to Remove Perfluorooctanoic Acid (PFOA) and Perfluorooctane Sulfonic Acid (PFOS) from Water

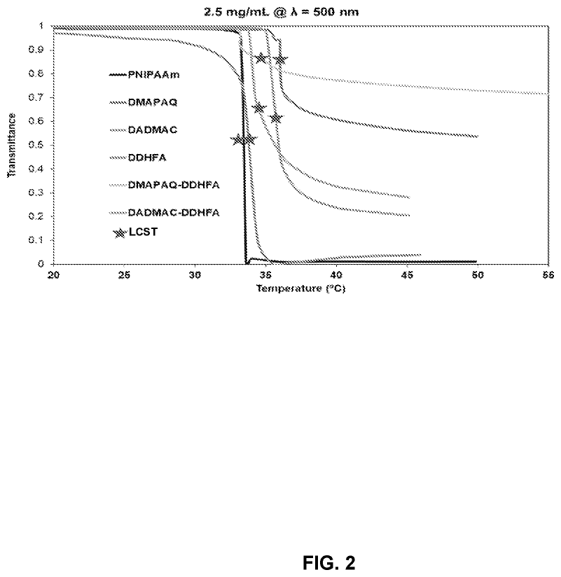

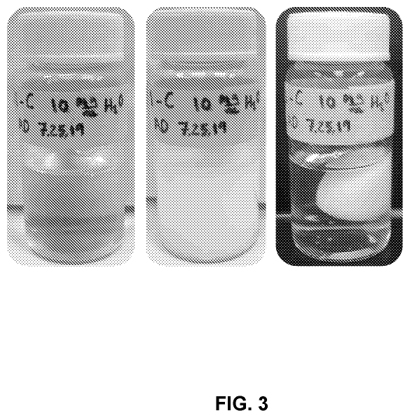

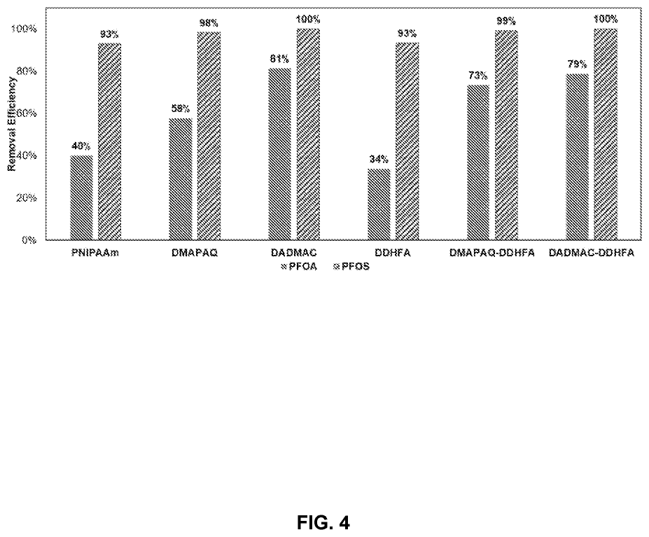

Polymer stock solutions (PNIPAAm, DMAPAQ, DADMAC, DDHFA, DMAPAQ-DDHFA, and DADMAC-DDHFA) may be prepared at 20 mg ml⁻¹ in DI water. A flocculation solvent containing NaCl at 0.228 M in DI water and the contaminants PFOA and PFOS at 285 ppb. The pH of the flocculation solvent may be adjusted to desired pH using 1 M NaOH. In a closed vial, the flocculation solvent and stock polymer solution may be added and adjusted to [NaCl]=0.2 M and [PFOA]=[PFOS]=250 ppb each, and polymer solution to 2500 mg L⁻¹ using DI water. The solution may be mixed for 5 minutes at 150 rpm. The flocculation process may be carried out in 50° C. water bath for one hour. A polymer floc will form which can be removed by filtering the solution using a Whatman grade 1 filter. Supernatant is analyzed for metal ions using Liquid Chromatography with tandem mass spectrometry (LC MS/MS). LCSTs were characterized as shown in FIG. 2. FIG. 3 shows the solution when first mixed at room temperature (left image, clear solution), the solution shortly after exposing solution to 50° C. water bath (center image, cloudy solution), and the solution after one hour of exposure to 50° C. water bath (right image, solid polymer floc visible). FIG. 4 shows the removal efficiency of PFOA and PFOS for these polymer systems.

### Example 7: Preparation of Random Multi-Component Polymer of NIPAAm and AAEM

Into a sealed shell vial may be placed 99 wt % of N-isopropylacrylamide (NIPAAm), 1 wt % of acetoxyethyl methacrylate (AAEM), and 2.5 wt % of 1-naphthylacrylate. These materials may be dissolved in DMSO and then 0.1 wt % of ammonium persulfate (pre-dissolved in DI water at 0.05 g ml⁻¹) may be added. The solution may be mixed for 10 minutes and may be purged with N₂ to remove dissolved oxygen. The polymerization may be carried out in 80° C. water bath for one hour. After polymerization, excess amount DI water may be sprayed into the shell vial and a sticky solid mass were precipitated out of solution. The multi-component polymer may be further purified by the following method. The crude product may be washed in DI water (200 ml) to remove unreacted monomer and DMSO. The product may be precipitated with addition of NaCl at elevated temperature (50° C.) to collect the dissolved polymers. This washing process may be repeated for three times, and the final polymer was dried in vacuum at 50° C. for 24 h. The process may yield of the random multi-component polymer.

### Example 8: Flocculation Studies to Remove Metal Ions from Acid Mine Drainage (AMD) Post Iron (III) Precipitation

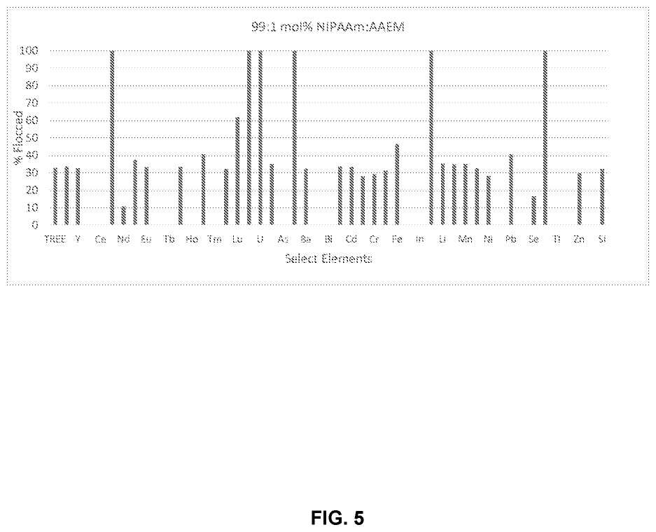

Polymer stock solutions may be prepared at 5 mg ml⁻¹ in DI water. In a closed vial, the stock polymer solution may be added to the AMD solution at a loading of 1 g ml⁻¹. The solution may be mixed for 5 minutes. The flocculation process may be carried out in 37° C. water bath for one hour. A polymer floc will form which can be removed by filtering the solution using a Whatman grade 1 filter. Supernatant is analyzed for metal ions using inductively coupled plasma optical emission spectrometry (ICP-OES). FIG. 5 shows the removal efficiency of various elements.

### Example 9: Preparation of Random Multi-Component Polymer of NIPAAm and 2-(methacryloyloxy)ethyl acetoacetate

Into a sealed shell vial may be placed 97.5 wt % of N-isopropylacrylamide (NIPAAm), 2.5 wt % of 2-(methacryloyloxy)ethyl acetoacetate and 2.5 wt % of 1-naphthylacrylate. These materials may be dissolved in DMSO and then 0.1 wt % of ammonium persulfate (pre-dissolved in DI water at 0.05 g ml⁻¹) may be added. The solution may be mixed for 10 minutes and may be purged with N₂ to remove dissolved oxygen. The polymerization may be carried out in 80° C. water bath for one hour. After polymerization, excess amount DI water may be sprayed into the shell vial and a sticky solid mass were precipitated out of solution. The multi-component polymer may be further purified by the following method. The crude product may be washed in DI water (200 ml) to remove unreacted monomer and DMSO. The product may be precipitated with addition of NaCl at elevated temperature (50° C.) to collect the dissolved polymers. This washing process may be repeated for three times, and the final polymer was dried in vacuum at 50° C. for 24 h. The process may yield of the random multi-component polymer.

### Example 10: Preparation of Random Multi-Component Polymer of NIPAAm, 2PPMA, and 1-Naphthyl acrylate

Into a sealed shell vial may be placed 95 wt % of N-isopropylacrylamide (NIPAAm), 2.5 wt % of 2-phenylphenolmonoacrylate (2PPMA), and 2.5 wt % of 1-naphthylacrylate. These materials may be dissolved in DMSO and then 0.1 wt % of ammonium persulfate (pre-dissolved in DI water at 0.05 g ml⁻¹) may be added. The solution may be mixed for 10 minutes and may be purged with N₂ to remove dissolved oxygen. The polymerization may be carried out in 80° C. water bath for one hour. After polymerization, excess amount DI water may be sprayed into the shell vial and a sticky solid mass were precipitated out of solution. The multi-component polymer may be further purified by the following method. The crude product may be washed in DI water (200 ml) to remove unreacted monomer and DMSO. The product may be precipitated with addition of NaCl at elevated temperature (50° C.) to collect the dissolved polymers. This washing process may be repeated for three times, and the final polymer was dried in vacuum at 50° C. for 24 h. The process may yield of the random multi-component polymer.

### Example 11: Random Multi-Component Polymer of NIPAAm, 2PPMA, and Dimethylaminoethyl Acrylate

Into a sealed shell vial may be placed 95 wt % of N-isopropylacrylamide (NIPAAm), 2.5 wt % of 2-phenylphenolmonoacrylate (2PPMA), and 2.5 wt % of dimethylaminoethyl acrylate. These materials may be dissolved in DMSO and then 0.1 wt % of ammonium persulfate (pre-dissolved in DI water at 0.05 g ml⁻¹) may be added. The solution may be mixed for 10 minutes and may be purged with N₂ to remove dissolved oxygen. The polymerization may be carried out in 80° C. water bath for one hour. After polymerization, excess amount DI water may be sprayed into the shell vial and a sticky solid mass were precipitated out of solution. The multi-component polymer may be further purified by the following method. The crude product may be washed in DI water (200 ml) to remove unreacted monomer and DMSO. The product may be precipitated with addition of NaCl at elevated temperature (50° C.) to collect the dissolved polymers. This washing process may be repeated for three times, and the final polymer was dried in vacuum at 50° C. for 24 h. The process may yield of the random multi-component polymer.

### Example 12: Random Multi-Component Polymer of NIPAAm, 2,2,2-Trifluoroethylacrylate, and Dimethylaminoethyl Acrylate

Into a sealed shell vial may be placed 95 wt % of N-isopropylacrylamide (NIPAAm), 2.5 wt % of trifluoroethyl acrylate, and 2.5 wt % of dimethylaminoethyl acrylate. These materials may be dissolved in DMSO and then 0.1 wt % of ammonium persulfate (pre-dissolved in DI water at 0.05 g ml⁻¹) may be added. The solution may be mixed for 10 minutes and may be purged with N₂ to remove dissolved oxygen. The polymerization may be carried out in 80° C. water bath for one hour. After polymerization, excess amount DI water may be sprayed into the shell vial and a sticky solid mass were precipitated out of solution. The multi-component polymer may be further purified by the following method. The crude product may be washed in DI water (200 ml) to remove unreacted monomer and DMSO. The product may be precipitated with addition of NaCl at elevated temperature (50° C.) to collect the dissolved polymers. This washing process may be repeated for three times, and the final polymer was dried in vacuum at 50° C. for 24 h.

The process may yield of the random multi-component polymer.

### Example 13: Preparation of Random Multi-Component Polymer of NIPAAm and 2PPMA

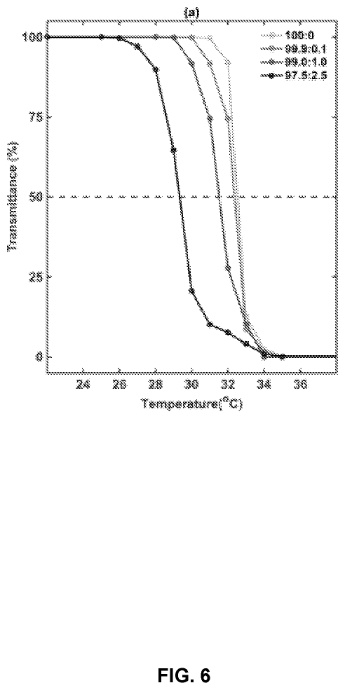

Into a sealed shell vial may be placed 97.5 wt % of N-isopropylacrylamide (NIPAAm), 2.5 wt % of 2-phenylphenolmonoacrylate (2PPMA). These materials may be dissolved in DMSO and then 0.1 wt % of ammonium persulfate (pre-dissolved in DI water at 0.05 g ml⁻¹) may be added. The solution may be mixed for 10 minutes and may be purged with N₂ to remove dissolved oxygen. The polymerization may be carried out in 80° C. water bath for one hour. After polymerization, excess amount DI water may be sprayed into the shell vial and a sticky solid mass were precipitated out of solution. The multi-component polymer may be further purified by the following method. The crude product may be washed in DI water (200 ml) to remove unreacted monomer and DMSO. The product may be precipitated with addition of NaCl at elevated temperature (50° C.) to collect the dissolved polymers. This washing process may be repeated for three times, and the final polymer was dried in vacuum at 50° C. for 24 h. The process may yield of the random multi-component polymer. LCSTs for varying composition of 2PPMA comonomer were characterized as shown in FIG. 6.

### Example 14: Flocculant Efficiency of NIPAAm 2PPMA Copolymer for Metal Oxide Nanoparticle (MONPs) Removal

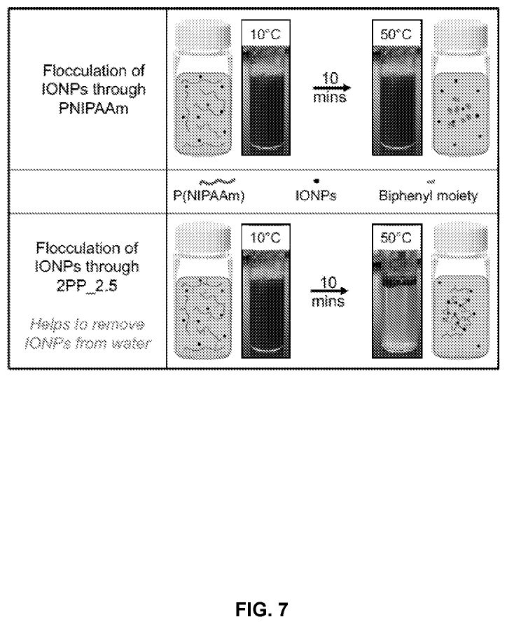

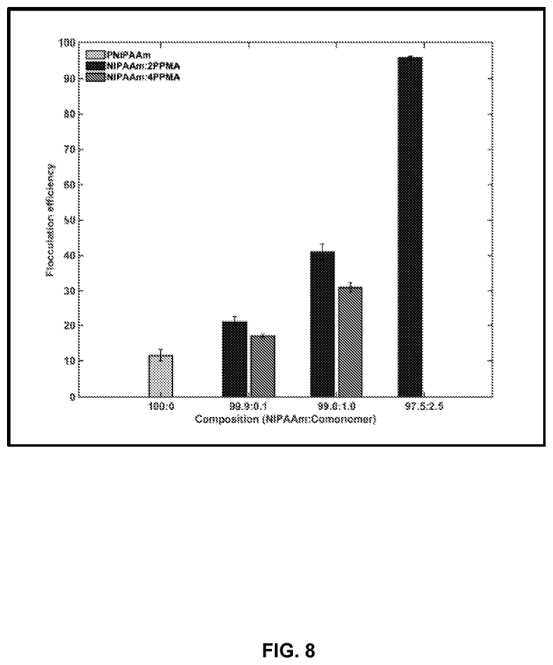

The flocculation efficiency of poly(NIPAAm) 2PPMA copolymer for the removal of Fe₃O₄ particles in aqueous suspension. MONPs at concentration of 0.1 mg ml⁻¹ were dosed with 1 mg ml⁻¹ of NIPAAm 2PPMA copolymer and a NaCL solution at 2M at room temperature. The flocculation was allowed to proceed at 50° C. for 10 min to reach complete equilibrium. The remaining Fe₃O₄ MONPs in the supernatant were quantitatively measured using iron assay (FIG. 7). We observed that the hydrophobic comonomer NIPAAm 2PPMA copolymer promoted flocculation for the MONPs producing a densely packed solid mass and clear supernatant. However, the same MONP suspension dosed with poly(NIPAAm) polymer produced sediments with high water retention and turbid supernatant. NIPAAm 2PPMA_2.5 copolymer flocculant has removed over 90% of the suspended particles at all MONP concentrations, as shown in FIG. 8. These results and observations indicate that flocculants with hydrophobic NIPAAm 2PPMA copolymer can induce more effective polymer bridging of the Fe₃O₄-polymer flocs. The comparisons of poly(NIPAAm) polymer and NIPAAm 2PPMA copolymer reveal that the hydrophobic modification can strongly affect the flocculation rate and removal efficiency of NIPAAm-based flocculants.

### Example 15: Removal of the Irritant Capsaicin from Surface of the Eye/Nose/Mouth

The proposed poly(NIPAAm) smart flocculant targets capsaicin, the active component of OC (“pepper spray”), in the ocular fluid to produce a floc that can be easily removed from the eye, thus preventing the irritation, pain, and further symptoms on the eye after exposure. This temperature-responsive polymer flocculant will bind, sequester, and remove capsaicin, the principal constituent in oleoresin capsicum or “pepper spray”, from the tear film. Thus, these polymers will be soluble within the eye drop solution at room temperature, but when administered to the eye, the polymers can bind to the target compound (e.g., capsaicin) and then flocculate upon interaction and the temperature change in the lacrimal fluid, allowing for removal from the eye. The biphenyl co-monomer modified NIPAAm based polymer results in a biphenyl rich polymer that is expected to interact with the vanilloid ring on capsaicin via pi-pi stacking interactions and Van der Waals interactions

### Example 16: Removal of the Viral Pathogens from Surface of the Eye/Nose/Mouth

The proposed poly(NIPAAm) smart flocculant targets the virus present in the ocular fluid to produce a floc that can be easily removed from the eye, preventing infection through the ocular route. Our cationic co-monomer modified NIPAAm based polymer is a smart flocculant, resulting in a positively charged polymer that is expected to interact with negative charges on COVID-19 virus particle surface, due to the presence of negatively charged amino-acid residues such as Glutamine, Asparagine, Threonine and Lysine. The smart flocculation mechanism proposed is based on poly(NIPAAm) chains and/or functional co-monomers interacting with the surface of the viral capsule through ionic interactions. Due to the LCST, the NIPAAm based polymers will be soluble within the eye drop solution at room temperature, but when administered to the eye, the polymers will bind to target contaminants (e.g., virus particles) and then flocculate with the temperature change in the eye fluid, resulting in removal from the eye. Taking advantage of the aforementioned residues, there is a potential to use more specific targeting than just charged interactions (i.e. using-amino acid residues) in future generation of the proposed smart flocculant.

What is claimed is:

1. A random multi-component polymer or salt thereof, the random multi-component polymer comprising two or more monomer components; wherein the random multi-component polymer or salt thereof is water miscible and associates with a soluble species or insoluble particle below a specific temperature and then at or above a specific temperature, converts to a flocculated random multi-component polymer or salt thereof is hydrophobic and easily separated from water.

2. A random multi-component polymer or a salt thereof, the random multi-component polymer comprising:
a. from about 50 wt % to about 99.8 wt % of a compound of Formula (I);
b. from about 0 wt % to about 50 wt % of a compound of Formula (II); and
c. from about 0 wt % to about 50 wt % of a compound of Formula (III);
wherein 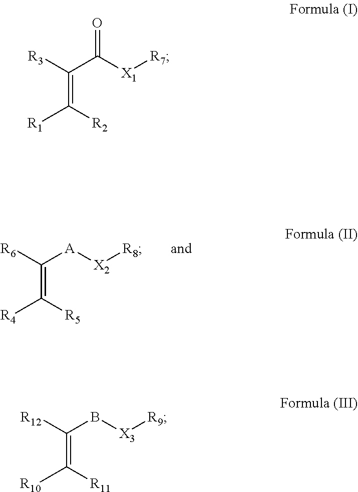
A and B are independently —CH₂— or C(═O);
X₁, X₂, and X₃ are independently CR₁₃R₁₄, O, NR₁₅, NH, S, substituted aryl, unsubstituted aryl, substituted heteroaryl, or unsubstituted heteroaryl;
R₁, R₂, R₃, R₄, R₅, R₆, R₁₀, R₁₁, and R₁₂ are independently hydrogen, substituted C₁-C₁₀ alkyl, unsubstituted C₁-C₁₀ alkyl, substituted C₁-C₁₀ alkenyl, unsubstituted C₁-C₁₀ alkenyl, substituted C₁-C₁₀ alkoxy, unsubstituted C₁-C₁₀ alkoxy, substituted C₁-C₁₀ alkynyl, or unsubstituted C₁-C₆ alkynyl; and
R₇, R₈, and R₉ are independently absent or selected from a group consisting of hydrogen, substituted C₁-C₁₀ alkyl, unsubstituted C₁-C₁₀ alkyl, substituted C₄-C₈ cycloalkyl, unsubstituted C₄-C₈ cycloalkyl, substituted C₁-C₁₀ alkenyl, unsubstituted C₁-C₁₀ alkenyl, substituted C₄-C₈ cycloalkenyl, unsubstituted C₄-C₈ cycloalkenyl, substituted C₁-C₁₀ alkynyl, unsubstituted C₁-C₁₀ alkynyl; substituted aryl, unsubstituted aryl, substituted heteroaryl, or unsubstituted heteroaryl.

3. The random multi-component polymer of claim 2, wherein A and B are independently —CH₂— or C(═O);
X₁, X₂, and X₃ are independently CR₁₃R₁₄, O, NH, substituted alkyl, unsubstituted alkyl, unsubstituted aryl, or substituted aryl;
R₁, R₂, R₃, R₄, R₅, and R₆ are independently hydrogen, substituted C₁-C₄ alkyl, unsubstituted C₁-C₆ alkyl, substituted C₁-C₆ alkenyl, unsubstituted C₁-C₆ alkenyl, substituted C₁-C₆ alkoxy, unsubstituted C₁-C₆ alkoxy, or substituted C₁-C₆ alkynyl, or unsubstituted C₁-C₆ alkynyl;
R₇, R₈, and R₉ are independently absent or selected from a group consisting of hydrogen, substituted C₁-C₄ alkyl, unsubstituted C₁-C₄ alkyl, substituted C₅-C₇ cycloalkyl, unsubstituted C₅-C₇ cycloalkyl, substituted C₁-C₆ alkenyl, unsubstituted C₁-C₆ alkenyl, substituted C₅-C₇ cycloalkenyl, unsubstituted C₅-C₇ cycloalkenyl, substituted C₁-C₆ alkynyl, unsubstituted C₁-C₆ alkynyl; substituted aryl, unsubstituted aryl, substituted heteroaryl, or unsubstituted heteroaryl; and
R₁₀, R₁₁, and R₁₂ are independently hydrogen, substituted C₁-C₄ alkyl, unsubstituted C₁-C₄ alkyl, substituted C₅-C₇ cycloalkyl, unsubstituted C₅-C₇ cycloalkyl, substituted C₁-C₄ alkenyl, unsubstituted C₁-C₁₀ alkenyl, substituted C₅-C₇ cycloalkenyl, unsubstituted C₅-C₇ cycloalkenyl, substituted C₁-C₄ alkynyl, unsubstituted C₁-C₄ alkynyl; substituted aryl, unsubstituted aryl, substituted heteroaryl, or unsubstituted heteroaryl.

4. The random multi-component polymer of claim 2, wherein A and B are independently —CH₂— or C(═O);
X₁, X₂, and X₃ are independently CR₁₃R₁₄, O, NH, unsubstituted aryl, or substituted aryl;
R₁, R₂, R₃, R₄, R₅, and R₆ are independently hydrogen, methyl, ethyl, propyl, isopropyl, benzyl, ethylene, propylene, or phenyl;
R₇, R₈, or R₉ are independently absent or selected from a group consisting of hydrogen, methyl, ethyl, propyl, isopropyl, benzyl, hexafluoroiso-propyl, 1H, 1H, 3H, hexafluorobutyl, 1H, 1H, 7H-dodecafluoroheptyl, 2,2,2-trifluoroethyl, 1H, 1H, 2H, 2H-heptafluorodecyl, 1H, 1H, 5H-octafluorodecyl, phenyl, 4-hydroxyphenyl, 4-hydroxy-3-ethylphenyl, 4 fluorophenyl, pentafluorophenyl, 2-hydroxyethyl, 3-hydroxypropyl, 2-aminoethyl, 3-aminopropyl; 2-carboxyethyl, 3 carboxypropyl, phenyl, naphthalene, anthracene, phenanthrene, phenalene, bi-phenyl, and cyclopentadienyl; and
R₁₀, R₁₁, and R₁₂ are independently hydrogen, methyl, ethyl, isopropyl, or propyl.

5. The random multi-component polymer of claim 2, wherein the polymer exhibits a lower critical solution temperature behavior from about 0° C. to about 100° C.

6. A process for preparing a random multi-component polymer which imparts a temperature responsiveness, the process comprises contacting the compound of Formula (I) with a compound of Formula (II) and a compound of Formula (III) to form the random multi-component polymer according to the following reaction scheme: 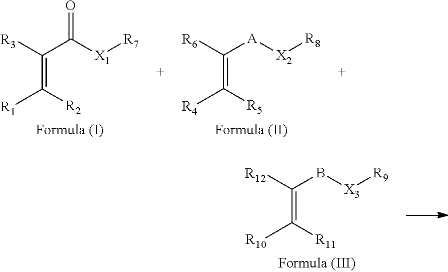
wherein A and B are independently —CH₂— or C(═O);
X₁, X₂, and X₃ are independently CR₁₃R₁₄, O, NR₁₅, NH, S, substituted aryl, unsubstituted aryl, substituted heteroaryl, or unsubstituted heteroaryl;
R₁, R₂, R₃, R₄, R₅, R₆, R₁₀, R₁₁, and R₁₂ are independently hydrogen, substituted C₁-C₁₀ alkyl, unsubstituted C₁-C₁₀ alkyl, substituted C₁-C₁₀ alkenyl, unsubstituted C₁-C₁₀ alkenyl, substituted C₁-C₁₀ alkoxy, unsubstituted C₁-C₁₀ alkoxy, substituted C₁-C₁₀ alkynyl, or unsubstituted C₁-C₆ alkynyl; and
R₇, R₈, or R₉ are independently absent or selected from a group consisting of hydrogen, substituted C₁-C₁₀ alkyl, unsubstituted C₁-C₁₀ alkyl, substituted C₄-C₈ cycloalkyl, unsubstituted C₄-C₈ cycloalkyl, substituted C₁-C₁₀ alkenyl, unsubstituted C₁-C₁₀ alkenyl, substituted C₄-C₈ cycloalkenyl, unsubstituted C₄-C₈ cycloalkenyl, substituted C₁-C₁₀ alkynyl, unsubstituted C₁-C₁₀ alkynyl; substituted aryl, unsubstituted aryl, substituted heteroaryl, or unsubstituted heteroaryl.

7. The process of claim 6, wherein A and B are independently —CH₂— or C(═O);
X₁, X₂, and X₃ are independently CR₁₃R₁₄, O, NH, substituted alkyl, unsubstituted alkyl, unsubstituted aryl, substituted aryl, or unsubstituted aryl;
R₁, R₂, R₃, R₄, R₅, and R₆ are independently hydrogen, substituted C₁-C₆ alkyl, unsubstituted C₁-C₆ alkyl, substituted C₁-C₆ alkenyl, unsubstituted C₁-C₆ alkenyl, substituted C₁-C₆ alkoxy, unsubstituted C₁-C₆ alkoxy, substituted C₁-C₆ alkynyl, or unsubstituted C₁-C₆ alkynyl;
R₇, R₈, or R₉ are independently absent or selected from a group consisting of hydrogen, substituted C₁-C₄ alkyl, unsubstituted C₁-C₄ alkyl, substituted C₅-C₇ cycloalkyl, unsubstituted C₅-C₇ cycloalkyl, substituted C₁-C₆ alkenyl, unsubstituted C₁-C₆ alkenyl, substituted C₅-C₇ cycloalkenyl, unsubstituted C₅-C₇ cycloalkenyl, substituted C₁-C₆ alkynyl, unsubstituted C₁-C₆ alkynyl; substituted aryl, unsubstituted aryl, substituted heteroaryl, or unsubstituted heteroaryl;
R₁₀, R₁₁, and R₁₂ are independently hydrogen, substituted C₁-C₄ alkyl, unsubstituted C₁-C₄ alkyl, substituted C₅-C₇ cycloalkyl, unsubstituted C₅-C₇ cycloalkyl, substituted C₁-C₄ alkenyl, unsubstituted C₁-C₄ alkenyl, substituted C₅-C₇ cycloalkenyl, unsubstituted C₅-C₇ cycloalkenyl, substituted C₁-C₄ alkynyl, unsubstituted C₁-C₄ alkynyl; substituted aryl, unsubstituted aryl, substituted heteroaryl, or unsubstituted heteroaryl.

8. The process of claim 6, wherein A and B are independently —CH₂— or C(═O);
X₁, X₂, and X₃ are independently CR₁₃R₁₄, O, NH, unsubstituted aryl, or substituted aryl;
R₁, R₂, R₃, R₄, R₅, and R₆ are independently hydrogen, methyl, ethyl, propyl, isopropyl, benzyl, ethylene, propylene, or phenyl;
R₇, R₈, or R₉ are independently absent or selected from a group consisting of hydrogen, methyl, ethyl, propyl, isopropyl, benzyl, hexafluoroiso-propyl, 1H, 1H, 3H, hexafluorobutyl, 1H, 1H, 7H-dodecafluoroheptyl, 2,2,2-trifluoroethyl, 1H, 1H, 2H, 2H-heptafluorodecyl, 1H, 1H, 5H-octafluorodecyl, phenyl, 4-hydroxyphenyl, 4-hydroxy-3-ethylphenyl, 4 fluorophenyl, pentafluorophenyl, 2-hydroxyethyl, 3-hydroxypropyl, 2-aminoethyl, 3-aminopropyl; 2-carboxyethyl, 3 carboxypropyl, phenyl, naphthalene, anthracene, phenanthrene, phenalene, bi-phenyl, cyclopentadienyl; and
R₁₀, R₁₁, and R₁₂ are independently hydrogen, methyl, ethyl, isopropyl, or propyl.

9. The process of claim 6, wherein the process further comprises using one or more free radical polymerization initiator(s).

10. The process of claim 9, wherein the free radical polymerization initiator is selected from a group consisting of an azo compound, an organic peroxide, an inorganic peroxide, ultraviolet light, and a combination thereof.

11. The process of claim 6, wherein the process further comprises the use of a solvent.

12. The process of claim 6, wherein the process is conducted at a temperature from about 0° C. to about 100° C.

13. A method of removing soluble species or insoluble particles from an aqueous solution, the method comprising:
(a) providing an aqueous solution comprising soluble species or insoluble particles;
(b) treating the aqueous solution comprising the soluble species or the insoluble particles with the random multi-component polymer of claim 6 at room temperature to form a first mixture;
(c) stirring the first mixture of the aqueous solution comprising soluble species or insoluble particles and the random multi-component polymer;
(d) heating the first mixture from step (c) above a lower critical solution temperature of the random multi-component polymer thereby promoting the random multi-component polymer to form a flocculated material; and
(e) filtering a flocculated material from step (d).

14. The method of claim 13, wherein the method further comprises deflocculating the flocculated material from step (e) and isolating the random multi-component polymer and the soluble species or insoluble particles.

15. The method of claim 14, wherein method comprises:
(f) suspending the flocculated material from step (e) in water, a solvent, or a combination thereof forming a second mixture;
(g) lowering the temperature of the second mixture below the lower critical solution temperature; and
(h) separating the random multi-component polymer from the soluble species or insoluble particles.

16. The method of claim 13, wherein the soluble species or insoluble particles comprise metals, metal oxides, metal oxide nanoparticles (MONP), metal ions, anions, clay, silica, kaolinite, alumina, oil, organic compound, or combinations thereof.

17. The method of claim 13, wherein the method is applied in removing soluble species during water treatment, removing environmental contaminants with low or high solubility, removing during water clarification, removing per- and polyfluoroalkyl substances (PFAS) or other environmental contaminants from groundwater, drinking water, wastewater, landfill leachate, reverse osmosis concentrate, or ion exchange brine.

18. The method of claim 13, wherein the lower critical solution temperature of the random multi-component polymer is from about 0° C. to about 100° C.

19. The method of claim 13, wherein the random multi-component polymer removes at least 50% of the soluble species or insoluble particles from the aqueous solution.

20. A method of removing soluble species or insoluble particles from an aqueous solution in a human body or a mammal body, the method comprising:
(a) providing an aqueous solution comprising soluble species or insoluble particles in the human body;
(b) treating the aqueous solution comprising soluble species or insoluble particles with a solution of the random multi-component polymer of claim 1 at room temperature to form a mixture in the human body or the mammal body;
(c) potentially providing mixing (rubbing, swishing, etc.) to the mixture of the aqueous solution comprising soluble species or insoluble particles and the random multi-component polymer;
(d) allowing the body temperature to heat the mixture from step (c) above a lower critical solution temperature of the random multi-component polymer thereby promoting the random multi-component polymer to form a flocculated material; and
(e) removing the flocculated material from step (d).
